(19) United States
(12) Patent Application Publication
(10) Pub. No.: US 2009/0232068 A1
(43) Pub. Date: Sep. 17, 2009

(54) METHOD FOR DYNAMICALLY ASSIGNING CHANNELS OF WIRELESS COMMUNICATION SYSTEM

(76) Inventors: Cheng-Hsuan WU, Taipei City (TW); Jiunn-Tsair Chen, HsinChu City (TW)

Correspondence Address: BIRCH STEWART KOLASCH & BIRCH, PO BOX 747, FALLS CHURCH, VA, 22040-0747, US

(21) Appl. No.: 12/357,798

(22) Filed: Jan. 22, 2009

(30) Foreign Application Priority Data
Mar. 14, 2008 (TW) 097109033

(51) Int. Cl. H04W 4/00

(52) U.S. Cl. 370/329

(57) ABSTRACT

The present invention provides a method for dynamic channel assignment for a wireless communication system. First, a respective channel allocation probability vector at each mobile terminal is randomly generated, and is then sent to the base stations covering the mobile terminal. Subsequently, the channel allocation probability vectors are integrated into channel allocation information for the mobile terminals covered by the base station. Afterwards, based on the channel allocation information, a corresponding channel allocation notice is sent to the mobile terminals covered by the base station, respectively. Finally, according to the channel allocation notice, the channels of the base station are assigned for the mobile terminals covered by the base station.

### BACKGROUND OF THE INVENTION

1. Field of the Invention

The present invention relates to a method for dynamically assigning channels and, more particularly, to a method for dynamically assigning channels of a wireless communication system.

2. Description of the Prior Art

With the development of wireless communication system and the increasing popularity of electronic equipments with wireless communication capabilities, such as notebooks, personal digital assistants (PDAs), mobile phones and the like, a user can use the electronic equipments to surf the internet conveniently in the region where the electronic equipments are communicable with wireless access points (APs). Besides, of the wireless communication technologies, MIMO (multiple input and multiple output) is one of the popular transmission structures in the new wireless communication applications.

Being different from a traditional wireless base station implemented through one antenna, MIMO is implemented through multiple antennas simultaneously, i.e. multiple antennas are disposed on a transmitting terminal and a receiving terminal, respectively. In other words, multiple parallel transmission channels for data transmission are constructed between the transmitting terminal (e.g. a wireless access point) and receiving terminal (e.g. a notebook). When one transmitting terminal or one receiving terminal is interfered or obstructed for some reasons, signals can be sent out through other paths to fulfill multiple transmissions. Therefore, MIMO can not only increase the data transmission amount but also extend the data transmission distance.

In the prior art, the utilization and assignments of the parallel transmission channels between the transmitting terminal and the receiving terminal depend on “Carrier Sense Multiple Access with Collision Avoidance, CSMA/CA.” However, this protocol makes the receiving terminal to get connection with the sending terminal through competition. For example, the receiving terminal gets connection with the sending terminal in two primary methods. One method is to assign parallel channels to the receiving terminal with the priority to access the transmitting terminal. The other method is to assign parallel channels to the receiving terminal with the strongest signal-to-interference and noise ratio (SINR). The shortcoming of the abovementioned two methods is that the parallel channels provided by the whole wireless communication networking may not be well-distributed, that is, the wireless communication networking is not well utilized.

As a result, the mechanism for assigning the parallel channels to the receiving terminal well has not been constructed yet, and thus in the modem wireless communication system, one receiving terminal only can connect to one transmitting terminal at one time. Although MIMO has the advantage of providing multiple parallel transmission channels, data only can be transmitted through limited parallel channels under the above situation. Instead, if one receiving terminal could use parallel transmission channels of multiple transmitting terminals simultaneously in the MIMO technology background, a higher transmission speed and a longer transmission distance would have been carried out.

To solve the aforementioned problem, the main scope of the present invention is to provide a method for dynamically assigning channels in a wireless communication system.

### SUMMARY OF THE INVENTION

An object of the present invention is to provide a method for dynamically assigning channels in a wireless communication system. The wireless communication system contains a plurality of mobile terminals and a plurality of base stations which each has a respective detection zone.

According to an embodiment of the present invention, the method contains the following steps. In the beginning, at each of the mobile terminals, a respective channel allocation probability vector is randomly generated, based on a first channel number constraint of said each mobile terminal, and then sent to the base stations capable of detecting said each mobile terminal.

Next, at each of the base stations, the channel allocation probability vectors sent from the mobile terminals detected by said each base station are received and integrated, based on a second channel number constraint of said each base station, into a respective set of probability formula. Then, according to an algorithm, the set of probability formula is solved to obtain channel allocation information for said mobile terminals detected by said each base station. Then, based on the channel allocation information, a corresponding channel allocation notice is sent to each of said mobile terminals detected by said each base station, respectively.

Finally, according to the channel allocation notice, the channels of said each base station are assigned to said mobile terminals detected by said each base station, respectively.

Compared to the prior art, the usage efficiency of the parallel transmission channels of the wireless communication system can be enhanced significantly by the method for dynamically assigning channels according to the present invention. Particularly, the method according to the present invention can make a mobile terminal use parallel transmission channels of multiple base stations simultaneously, which will realize the higher transmission speed and the longer transmission distance.

The advantage and spirit of the present invention may be understood by the following recitations together with the appended drawings.

### BRIEF DESCRIPTION OF THE APPENDED DRAWINGS

FIG. 1 illustrates a schematic diagram of a wireless communication system according to one embodiment of the present invention.

FIG. 2 illustrates a schematic diagram of a possible parallel-channel allocation for a mobile terminal by taking the mobile terminal (M3) and the base stations (BS1 and BS2) shown in FIG. 1 for example.

FIG. 3 illustrates a schematic diagram of a possible parallel-channel allocation for a base station by taking the base station (BS2) and the mobile terminals (M3, M4, and M5) shown in FIG. 1 for example.

FIG. 4 illustrates a schematic diagram of one wireless communication system model which applies the method for dynamically assigning channels according to the present invention and is used for simulation.

FIG. 5 illustrates the simulation results of the wireless communication system model shown in FIG. 4.

FIGS. 6A and 6B illustrate a flow chart of the method for dynamically assigning channels according to the present invention.

### DETAILED DESCRIPTION OF THE INVENTION

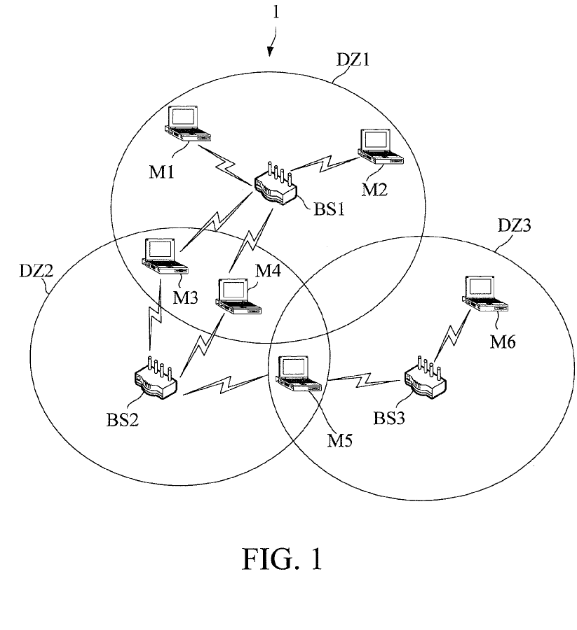

Please refer to FIG. 1. FIG. 1 illustrates a schematic diagram of a wireless communication system 1 according to one embodiment of the present invention.

As shown in FIG. 1, the wireless communication system 1 contains a plurality of mobile terminals (M1˜M6) and a plurality of base stations (B1˜B3). Each base station has a respective detection zone (DZ1˜DZ3).

In the embodiment, the wireless communication system 1 uses MIMO technology, but it is not limited herein in practical applications. For the wireless communication system 1, MIMO takes a synchronization structure of multiple inputs and multiple outputs, that is, multiple antennas are disposed at a mobile terminal and a base station, respectively. When one of the parallel transmission channels between the base station and the mobile terminal is interfered or obstructed for some reasons, signals can be sent out by other parallel transmission channels. However, whether it is the base station or the mobile terminal, the maximum number of the parallel transmission channels depends on the number of the antennas. In other words, the allocations of the parallel transmission channels of the base station and the mobile terminal conform to a respective constraint.

Before the analysis of the constraint, each of the mobile terminals and the base stations is defined as an agent node according to the method of the present invention. Besides, the number of parallel transmission channels between each of the mobile terminals and each of the base stations is defined as a variable. Therefore, the information about the dynamic channels of the wireless communication system is transmitted between the agent nodes continuously. It is noted that a normal graph theory is used for the above defining method. Particularly, this defining method is well known in the codec field, but researches on the dynamical channel allocation by using the normal graph theory have not been presented in the wireless communication field.

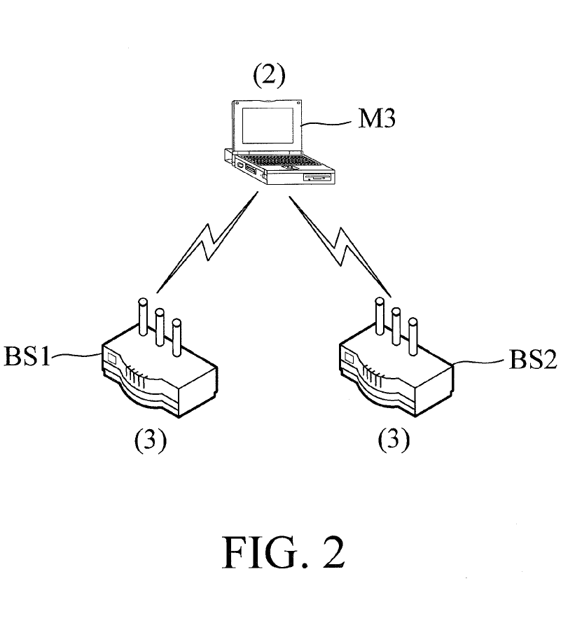

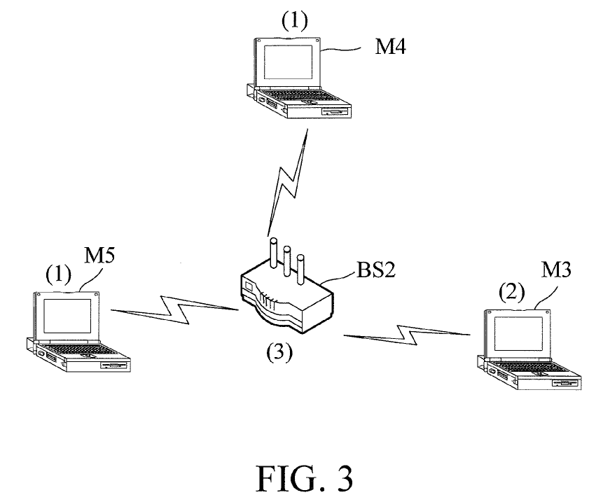

Please refer to FIG. 2 and FIG. 3. FIG. 2 illustrates a schematic diagram of a possible parallel-channel allocation for a mobile terminal by taking the mobile terminal (M3) and the base stations (BS1 and BS2) shown in FIG. 1 for example. FIG. 3 illustrates a schematic diagram of a possible parallel-channel allocation for a base station by taking the base station (BS2) and the mobile terminals (M3, M4, and M5) shown in FIG. 1 for example.

As shown in FIG. 2, it is supposed that the mobile terminal (M3) provides two antennas, which is represented as (2). It is supposed that each of the base stations (BS1 and BS2) provides three antennas, which is represented as (3). Therefore, a possible allocation of the parallel transmission channels among the mobile terminal (M3) and the base stations (BS1 and BS2) is represented as [20 02 11 10 01 00]. There are six sets of values in the parenthesis, where the left number of each value represents the number of the parallel transmission channel between the mobile terminal (M3) and the base station (BS1), and the right number of each value represents the number of the parallel transmission channel between the mobile terminal (M3) and the base station (BS2). In principle, the sum of the left number and the right number for each value is not over 2. It means that the number of the parallel transmission channels constructed among the mobile terminal (M3) and the base stations (BS1 and BS2) is not over the number of the antennas provided by the mobile terminal (M3), i.e. two antennas.

Similarly, as shown in FIG. 3, a possible allocation of the parallel transmission channels among the base station (BS2) and the mobile terminals (M3, M4, and M5) is represented as [102 111 012 101 002 011 100 010 000]. The numbers from left to right in each value represent the parallel transmission channels between the base station (BS2) and the mobile terminals (M3, M4, and M5), respectively. In the same way, the sum of the numbers in each value is not over 3. It means that the number of the parallel transmission channels constructed among the base station (BS2) and the mobile terminals (M3, M4, and M5) is not over the number of the antennas provided by the base station (BS2), i.e. three antennas.

Please refer to FIG. 1 again. After a possible parallel transmission allocation at each of the mobile terminals (M1˜M6) or each of the base stations (BS1˜BS3) is decided according to its constraint, each of the mobile terminals randomly generates, based on a first channel number constraint of said each mobile terminal, a respective channel allocation probability vector, and sends the channel allocation probability vector to the base stations capable of detecting said each mobile terminal.

Please refer to FIG.3 again. For example, the mobile terminal (M3) randomly generates a probability vector [0.2 0.5 0.3] to the base station (BS2), where the probability values from left to right in the vector represent the probability of the number of the parallel-transmission-channel (1, 2, and 3) for the mobile terminal (M3), respectively. If the mobile terminal (M3) is in the detection zones of the base stations, the mobile terminal (M3) randomly generates independent probability vectors and sends these vectors to each of the base stations, respectively. For example, the mobile terminal (M3) shown in FIG. 1 will randomly generate two independent probability vectors to the base stations (BS1 and BS2), respectively.

Next, each of the base stations receives the channel allocation probability vectors sent from the mobile terminals detected by said each base station, and integrates, based on a channel number constraint of said each base station, the channel allocation probability vectors into a respective set of probability formula.

Take the base station (BS2) and the mobile terminals (M3, M4, and M5) shown in FIG. 3 for an example. The base station (BS2) receives the channel allocation probability vectors sent from the mobile terminals (M3, M4, and M5). Then, based on the channel number of the mobile terminal (M5), the base station (BS2) integrates the channel allocation probability vectors sent from the mobile terminals (M3, M4, and M5) into a set of probability formula for the mobile terminal (M5) as follows:

Pr(X=0)=C1*Extrinsic[Pr(102)+Pr(101)+Pr(100)+Pr(000)]; and Formula 1:

Pr(X=1)=C1*Extrinsic[Pr(111)+Pr(012)+Pr(011)+Pr(110)+Pr(010)] Formula 2:

where X represents the channel number, the probability value of Pr(111) represents the product of the probabilities in the channel allocation vectors of the mobile terminals (M3, M4, and M5), where each probability corresponds to a channel number of 1. Other probability values are obtained in the same way. Taking the calculation of Pr(X=1) for example, “Extrinsic” represents that the probability corresponding to a channel number of 1 in the channel allocation vector of the mobile terminal M5 is not put into Formula 2.

In the same way, a respective set of probability formula can be obtained for each of the mobile terminals (M3 and M4).

Then, according to an algorithm, each set of the probability formulas can be figured out. Taking the mobile terminal M5 for an example, an integration probability vector [Pr(X=0) Pr(X=1)] can be obtained by the algorithm. In the same way, a respective integration probability vector can be obtained for each of the mobile terminals (M3 and M4) by the algorithm.

In one embodiment, the algorithm can be a sum-product algorithm or a max-product algorithm, but it is not limited herein.

The integration probability vectors can provide channel allocation information for the mobile terminals (M3, M4, and M5) detected by each base station, e.g. BS2.

Then, based on the channel allocation information, a corresponding channel allocation notice is sent to each of the mobile terminals detected by each base station. In detail, each above integration probability vector can express the channel allocation notice. For example, the integration probability vector [Pr(X=0) Pr(X=1)] can express the channel allocation notice of the mobile terminal M5, where Pr(X=0) represents the probability of zero parallel transmission channel constructed between the mobile terminal M5 and the base station BS2, and Pr(X=1) represents the probability of one parallel transmission channel constructed between the mobile terminal M5 and the base station BS2. According to the probability value of Pr(X=0) and Pr(X=1), e.g. choosing the bigger one, the channel allocation notice is used to notice the mobile terminal M5 that zero or one parallel transmission channel will be allocated by the base station BS2.

Next, in the embodiment, if an allocated channel number associated with the channel allocation notice meets the channel number constraint of each mobile terminal is judged at each mobile terminal. For example, it is judged at the mobile terminal M5 that whether a total allocated channel number of the mobile terminal M5 assigned by the base stations (BS2 and BS3) is bigger than the number of the antennas of the mobile terminal M5 or not.

If it is not bigger than the number of the antennas of the mobile terminal M5, a corresponding confirmation message is sent to the base stations capable of detecting the mobile terminals; if YES, a respective channel allocation probability vector is randomly generated at the mobile terminals again and sent to the base stations capable of detecting the mobile terminals.

Then, it is judged at each of the base stations that whether each mobile terminal covered by said each base station finishes sending the corresponding confirmation message. If YES, based on the channel allocation notice, said each base station allocates the channels thereof to the mobile terminals covered by said each base station. If NO, said each base station sends a renewal notice to each mobile terminal covered by said each base station to randomly generate a respective channel allocation probability vector again and execute the following steps.

In one embodiment, each mobile terminal further applies a selective weighting to the channel allocation probability vector, and then sends the weighted channel allocation probability vector to the base stations capable of detecting said each mobile terminal.

For example, a possible allocation of the parallel transmission channels between the mobile terminal M3 and the base stations (BS1 and BS2) is represented as [20 02 11 10 01 00]. In general, it is better for the user that more parallel transmission channels are assigned to the mobile terminal M3 by the base stations (BS1 and BS2) since the higher transmission speed and longer transmission distance can be reached under this condition. Therefore, a weighting vector [10² 10² 10² 10¹ 10¹ 10⁰] can be added to the channel allocation probability vector of the mobile terminal M3 and be sent to the base stations (BS1 and BS2) together. Then, the weighting vector [10² 10² 10² 10¹ 10¹ 10⁰] can be applied to the probability formula so that the probability of more parallel transmission channels assigned to the mobile terminal M3 increases.

Alternatively, the base station applies a selective weighting to the channel allocation probability vectors, and then integrates, based on the channel number constraint of the base station, the channel allocation probability vectors into the respective set of probability formula.

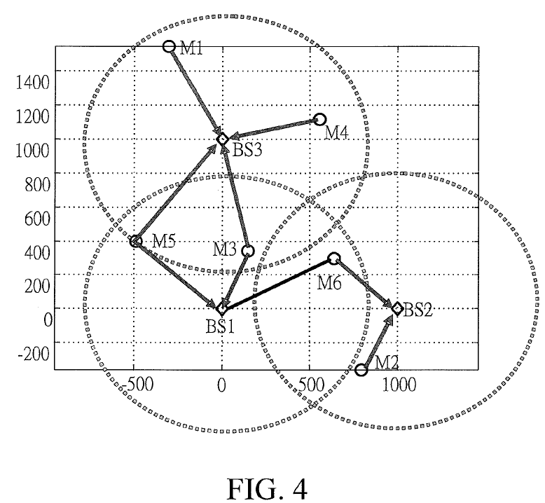

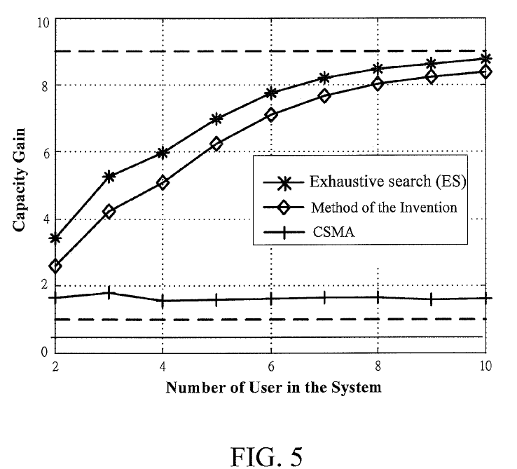

Please refer to FIG.4 and FIG. 5. FIG. 4 illustrates a schematic diagram of one wireless communication system model which applies the method for dynamically assigning channels according to the present invention and is used for simulation. FIG. 5 illustrates the simulation results of the wireless communication system model shown in FIG. 4.

In FIG. 4, BS represents a base station, M represents a mobile terminal, and the numbers along the vertical axis and the horizontal axis represent the coordinates of the base station and the mobile terminal, respectively, e.g. a Cartesian Plane. In FIG. 5, the term “capacity gain” represents the parallel transmission channel number assigned to the mobile terminal. Besides, the three methods relating to the dynamical channel allocation (DCA) are executed in the background of a MIMO technique. “CSMA” is the above-mentioned protocol of “Carrier Sense Multiple Access with Collision Avoidance”. ES means an “exhaustive search”, meaning that a supercomputer monitors and adjusts the DCA condition of the whole wireless communication system all the time to reach the optimum usage efficiency for the dynamic channels provided by the whole wireless communication system. However, the equipment cost and maintenance cost of the supercomputer are so high that it is not feasible in practice.

As shown in FIG. 5, the performance of the DCA according to the present invention is much better than the well-known CSMA and almost equal to ES. Preferably, the method of the present invention can reach the performance almost equal to that of ES without high cost.

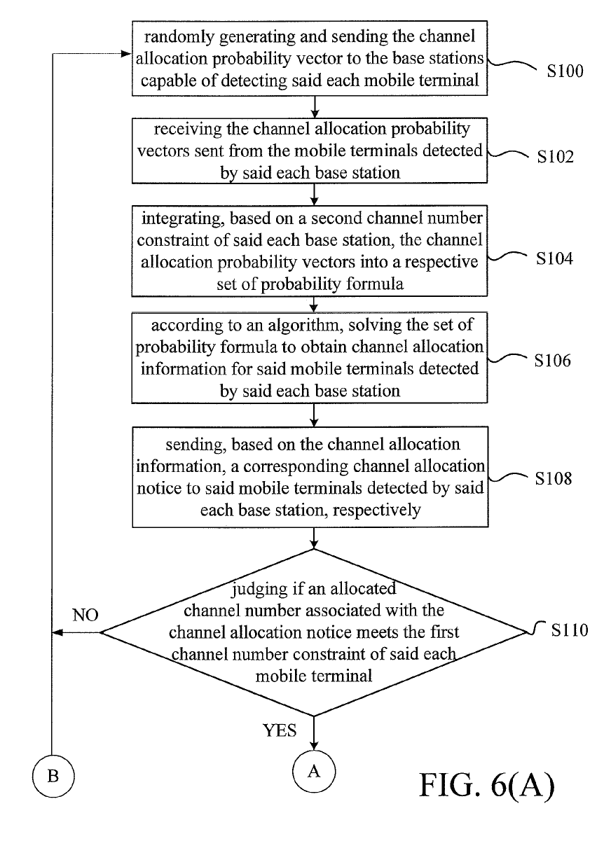

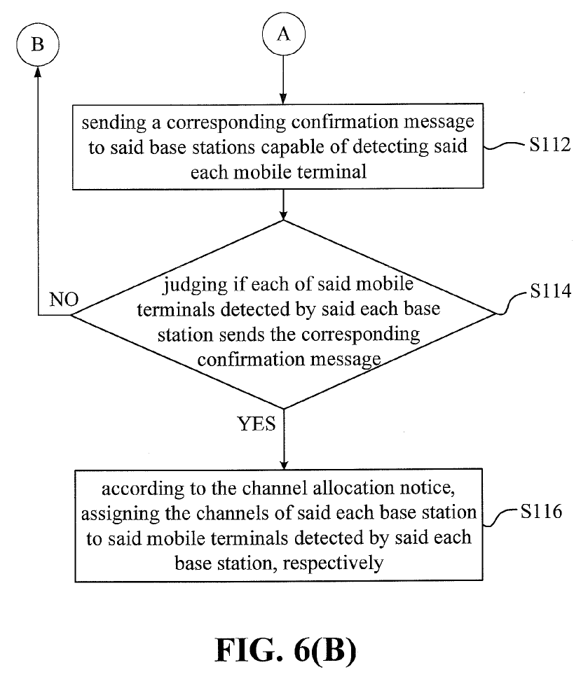

In summary, please refer to FIGS. 6A and 6B. FIGS. 6A and 6B illustrate a flow chart of the method for dynamically assigning channels according to the present invention.

First, by executing step S100, at each of the mobile terminals, a respective channel allocation probability vector is randomly generated, based on a channel number constraint of said each mobile terminal, and then sent to the base stations capable of detecting said each mobile terminal.

Next, by executing step S102, the channel allocation probability vectors sent from the mobile terminals detected by each base station are received at said each base station.

Then, by executing step S104, the channel allocation probability vectors are integrated, based on a channel number constraint of said each base station, into a respective set of probability formula.

Next, by executing step S106, at the base station, the respective set of probability formula is solved, according to an algorithm, to obtain channel allocation information for the mobile terminals detected by said each base station.

Subsequently, by executing step S108, based on the channel allocation information, a corresponding channel allocation notice is sent to the mobile terminals detected by said each base station, respectively.

In one embodiment, steps S110˜S114 can be executed subsequently.

By executing step S110, it is judged that if an allocated channel number associated with the channel allocation notice meets the channel number constraint of each mobile terminal. If YES, by executing step S112, a corresponding confirmation message is sent to the base stations capable of detecting said each mobile terminal; If NO, step S100 is repeated.

Then, by executing step S114, it is judged that whether said each mobile terminal covered by the base stations finishes sending the corresponding confirmation message. If YES, by executing step S116, based on the channel allocation notice, the channels of the base stations are allocated to the mobile terminals covered by the base stations; If NO, a renewal notice is sent to each mobile terminal covered by the base stations, and step S100 is repeated.

Compared to the prior art, the using efficiency of the parallel transmission channels of the wireless communication system can be enhanced significantly by the method for dynamically assigning channels according to the present invention. Particularly, the method according to the present invention can make a mobile terminal use parallel transmission channels of multiple base stations simultaneously, which will realize the higher transmission speed and the longer transmission distance.

With the example and explanations above, the features and spirits of the present invention will be hopefully well described. Those skilled in the art will readily observe that numerous modifications and alterations of the device may be made while retaining the teaching of the present invention. Accordingly, the above disclosure should be construed as limited only by the metes and bounds of the appended claims.

What is claimed is:

1. A method for dynamically assigning channels of a wireless communication system comprising a plurality of mobile terminals and a plurality of base stations which each has a respective detection zone, the method comprising the steps of:
(a) at each of the mobile terminals, randomly generating a respective channel allocation probability vector, and sending the channel allocation probability vector to the base stations capable of detecting said each mobile terminal;
(b) at each of the base stations, receiving the channel allocation probability vectors sent from the mobile terminals detected by said each base station;
integrating the channel allocation probability vectors into a respective set of probability formula; according to an algorithm, solving the set of probability formula to obtain channel allocation information for said mobile terminals detected by said each base station; sending, based on the channel allocation information, a corresponding channel allocation notice to each of said mobile terminals detected by said each base station, respectively; and
(c) assigning the channels of said each base station to said mobile terminals detected by said each base station, respectively, according to the channel allocation notice.

2. The method of claim 1, wherein step (b) also comprises the steps of:
(b1) at said each mobile terminal, judging if an allocated channel number associated with the channel allocation notice meets the first channel number constraint of said each mobile terminal; if YES, sending a corresponding confirmation message to said base stations capable of detecting said each mobile terminal; and
(b2) at said each base station, judging if each of said mobile terminals detected by said each base station sends the corresponding confirmation message; if YES, proceeding to step (c).

3. The method of claim 2, wherein if NO in step (b1), repeats steps (a) and (b).

4. The method of claim 2, wherein if NO in step (b2), sends a renewal notice from said each base station to said mobile terminals covered by said each base station to repeat steps (a) and (b).

5. The method of claim 1, wherein in step (a), said each mobile terminal applies a selective weighting to the channel allocation probability vector, and then sends the channel allocation probability vector to said base stations detecting said each mobile terminal.

6. The method of claim 1, wherein in step (b), said each base station applies a selective weighting to the channel allocation probability vectors sent from said mobile terminals detected by said each base station, and then integrates, based on the second channel number constraint of said each base station, the channel allocation probability vectors into the respective set of probability formula.

7. The method of claim 1, wherein the algorithm is a sum-product algorithm or a max-product algorithm.

8. The method of claim 1, wherein MIMO (multiple input and multiple output) technology is used in the wireless communication system.

9. The method of claim 1, wherein the step of randomly generating a respective channel allocation probability vector is based on a first channel number constraint of said each mobile terminal.

10. The method of claim 1, wherein the step of integrating the channel allocation probability vectors into a respective set of probability formula is based on a second channel number constraint of said each base station.
